(19) United States
(12) Patent Application Publication
(10) Pub. No.: US 2026/0046487 A1
(43) Pub. Date: Feb. 12, 2026

(54) METHOD AND APPARATUS FOR PROVIDING SERVICE BASED ON EMOTION INFORMATION OF USER ABOUT CONTENT

(71) Applicant: TVING CO., LTD., Seoul (KR)

(72) Inventor: Ji Hoon HAN, Seoul (KR)

(21) Appl. No.: 19/363,789

(22) Filed: Oct. 21, 2025

Related U.S. Application Data
(63) Continuation of application No. PCT/KR2024/005420, filed on Apr. 22, 2024.

(30) Foreign Application Priority Data
Apr. 21, 2023 (KR) 10-2023-0052727

(51) Int. Cl. H04N 21/4722; H04N 21/234; H04N 21/25; H04N 21/2668; H04N 21/431

(52) U.S. Cl. CPC H04N 21/4722; H04N 21/23418; H04N 21/251; H04N 21/2668; H04N 21/4316

(57) ABSTRACT

Provided is an operating method of a server, comprising obtaining emotion information of a user about at least one scene constituting content played on an electronic device; producing an additional content including the emotion information of the user, and providing an additional service based on the content into the electronic device, based on at least one of factor information representing a factor by which the emotion information of the user about the at least one scene is obtained and the additional content.

### CROSS-REFERENCE TO RELATED APPLICATION(S)

The application is a Continuation of International Application No. PCT/KR2024/005420, filed on Apr. 22, 2024, which claims the benefit of priority to Korean Patent Application 10-2023-0052727, filed on Apr. 21, 2023, the entire disclosures of which are incorporated herein by references in their entirety.

### TECHNICAL FIELD

Related are a method and apparatus for providing services based on emotion information of a user about a content.

### BACKGROUND ART

As consumption of online and mobile videos increases rapidly due to ultrahigh-speed mobile communication and widespread of smartphones, in addition to conventional TV-based broadcasting platforms such as terrestrial broadcasting and cable broadcasting, satellite broadcasting, IPTV and the like, OTT (Over-The-Top) services, which are online streaming platforms on the web and mobile, are expanding. The OTT market size is increasing every year, and as mobile communication technologies develop, the demand for the OTT services is expected to increase further more.

Accordingly, in the OTT services, services which are not provided in the conventional broadcasting platform, or services that can provide users with enjoyment while using a content have been developed.

However, conventional OTT services present a technical problem related to system efficiency. When users manually search for specific scenes by repeatedly using seeking functions, it generates numerous requests for different segments of the video data. This not only results in a poor user experience but also causes unnecessary data streaming, which leads to a significant increase in the computational load on the server and inefficient use of network bandwidth. This technical challenge makes it difficult to provide a stable and scalable service. Therefore, there is a need for a technical solution that can reduce server-side data processing and user input required for content exploration.

Regarding new content discovery, existing recommendation engines typically rely on coarse data such as viewing history or simple ratings. They lack the capability to understand a user's granular emotional responses to specific scenes, thus often failing to recommend new content that truly resonates with the user's emotional preferences.

### DISCLOSURE

### Technical Problem

It is to allow to easily record emotions that users feel while watching a content in real time.

It is to provide an additional service including an additional content based on scenes in which users record their emotions.

### Technical Solution

According to one aspect, an operating method of a server, comprising obtaining emotion information of a user about at least one scene constituting a content played on an electronic device; generating an additional content including the emotion information of the user; and providing an additional service based on the content into the electronic device, based on at least one of factor information representing a factor by which the emotion information of the user about the at least one scene is obtained and the additional content.

According to one example, the obtaining emotion information of a user about at least one scene, may comprise receiving the emotion information of the user about the entire scene constituting the content or a part of the scene, based on an emotion emoticon preset from the electronic device.

According to one example, the operating method of a server may further comprise obtaining factor information representing a factor by which the emotion information of the user about the at least one scene is obtained, and the obtaining factor information representing the factor may conduct obtaining configuration information of the at least one scene, including information of objects displayed in the at least one scene and story information of the at least one scene; and obtaining factor information representing a factor by which the emotion information of the user is obtained, based on results of analyzing a corresponding relation between the configuration information of the at least one scene and the emotion information.

According to one example, the operating method of a server may further comprise obtaining reference scenes constituting a plurality of contents and emotion information of a plurality of users about the reference scenes; and generating a first learning model determining factor information representing a factor by which the emotion information of the plurality of users is obtained, based on results of learning configuration information of the reference scenes and the emotion information of the plurality of users.

According to one example, the operating method of a server may further comprise obtaining the at least one scene and the emotion information of the user about the at least one scene as input values of a first learning model; and obtaining factor information representing a factor by emotion information of the user is obtained about the at least one scene as output values from the first learning model.

According to one example, the operating method of a server may further comprise collecting reference scenes constituting a plurality of contents and emotion information of a plurality of users about the reference scenes; and generating a second learning model predicting an interest scene of a certain user in a certain content and emotion information about the interest scene, based on results of learning configuration information of the reference scenes and emotion information of the plurality of users.

According to one example, the providing an additional service based on the content into the electronic device may comprise obtaining factor information representing a factor by which the emotion information of the user about the at least one scene constituting the content is obtained and information of a content different from the content are obtained as input values of the second learning model; and obtaining at least one interest scene of the user in the different content and emotion information about the at least one interest scene as output values by predicting them from the second learning model; and providing an interest content based on the at least one interest scene.

According to one example, the additional service based on the content may comprise a curation service for the additional content and at least one content related to the content.

According to one example, the additional content may be an image in which the emotion information of the user is displayed in the at least one scene, and the providing an additional service based on the content may comprise at least one step of providing the additional content, when an input for selecting a thumbnail of the additional content is obtained; and displaying and providing a playback time of the at least one scene on a search bar while the content or the additional content is being played.

According to one example, the providing an additional service based on the content, may comprise providing a preview of a content without playback history, based on factor information representing a factor by which the emotion information of the user about the at least one scene of the content is obtained.

According to one example, the operating method of a server may further comprise collecting emotion information about scenes constituting a plurality of contents, for each of a plurality of users; classifying the plurality of users into a plurality of groups, based on the emotion information of the plurality of users; and providing a curation service for a plurality of contents, for each of the plurality of groups.

According to one example, the operating method of a server may further comprise providing a space capable of conducting a community, for each of the plurality of groups.

According to one example, the providing a curation service may comprise providing a thumbnail list of interest scenes predicted to be of interest to users in a group, for each of the plurality of groups, and the thumbnail list comprises thumbnails representing high ranking scenes selected according to preset criteria.

According to another aspect, provided is a server, comprising a communication device which performs communication with an external device; a processor; and a memory storing instructions executable by the processor, wherein the processor executes the instructions, thereby obtaining emotion information of a user about at least one scene constituting a content played on an electronic device, and generating an additional content including the emotion information of the user, and providing an additional service based on the content into the electronic device, based on at least one of factor information representing a factor by which the emotion information of the user is obtained about the at least one scene and the additional content.

According to other aspect, provided is a computer program stored in a computer readable storage medium to execute the operating method of a server.

According to one aspect, provided is an operating method of an electronic device, comprising receiving emotion information of a user about at least one scene constituting the content, as a content is played; transmitting playback time information of the at least one scene and emotion information of the user to a server; receiving an additional content including the emotion information of the user from the server; and providing an additional service based on the content, based on at least one of factor information representing a factor by which the emotion information of the user about the at least one scene is analyzed and the additional content.

According to one example, the receiving the emotion information of the user for the at least one scene, may comprise receiving the emotion information of the user about the entire scene constituting the content or a part of the scene, based on a preset emotion emoticon.

According to one example, the additional service based on the content may comprise a curation service for the additional content and at least one content related to the content.

According to one example, the providing an additional service based on the content may comprise at least one step of providing the additional content, when an input for selecting a thumbnail of the additional content is obtained; and displaying a playback time of the at least one scene on a search bar while the additional content is being played.

According to one example, the providing an additional service based on the content, may comprise providing a preview of a content without playback history, based on factor information representing a factor by which the emotion information of the user about the at least one scene of the content is analyzed.

According to one example, the operating method of an electronic device may further comprise providing a service capable of conducting communication with a member of a group classified as the same group as the user based on factor information representing a factor by which the emotion information of the user about the at least one scene is analyzed.

According to one example, the providing an additional service based on the content, may comprise providing a curation service for a plurality of contents, based on a content watched by the member of the group.

According to one example, the providing a curation service for the plurality of contents may comprise providing a thumbnail list of interest scenes, based on a content watched by the member of the group, and the thumbnail list comprises thumbnails representing high ranking scenes selected according to preset criteria.

According to other aspect, provided is an electronic device, comprising a communication device which performs communication with an external device; a user interface device; a processor; and a memory storing instructions executable by the processor, wherein the processor executes the instructions, thereby playing a content through the user interface device, and receiving emotion information of a user about at least one scene constituting the content, and transmitting playback time information of the at least one scene and the emotion information of the user into a server, through the communication device, and receiving an additional content including the emotion information of the user from the server, and providing an additional service based on the content, based on at least one of factor information representing a factor by which the emotion information of the user is analyzed for the at least one scene, by executing the instructions.

According to other aspect, provided is a computer program stored in a computer readable storage medium to execute an operating method of an electronic device.

### Advantageous Effects

Emotions which users feel while watching a content can be easily recorded in real time.

Additional services including an additional content can be provided based on scenes in which users record emotions.

Furthermore, the present disclosure provides a significant technical advantage by improving the operational efficiency of the content delivery system. For content exploration, by enabling users to directly access scenes of interest, the method reduces the amount of server-side data processing required for content exploration. This reduction in manual seeking and redundant data requests decreases the computational load on the server and enhances network efficiency, allowing for a more stable and scalable service to be delivered.

For new content discovery, by analyzing granular, scene-level emotion data, the invention allows for the prediction and recommendation of new content that is highly likely to elicit a desired emotional response from the user. This provides a more sophisticated and effective personalization than is possible with conventional systems.

### DESCRIPTION OF DRAWINGS

The present disclosure may be easily understood in combination with the following detailed description and drawings accompanying thereto, and reference numerals refer to structural elements.

FIG. 1 is a conceptual diagram for explaining operation of an electronic device and a server that provide an additional service based on a scene in which a user expresses emotions while watching a content, according to one example.

FIG. 2 is a flow chart showing an operation method of a server that provides an additional service based on emotion information of a user about a scene in a content obtained from an electronic device.

FIG. 3A and FIG. 3B are diagrams for describing a process of obtaining emotion information of a user about one scene constituting a content played on an electronic device, according to one example.

FIG. 4 is a flow chart showing a method of obtaining factor information showing a factor by which emotion information of a user about a scene is obtained, according to one example.

FIG. 5 is a diagram for describing a process of obtaining factor information showing a factor by which emotion information about a scene in which emotion information of a user is inputted is obtained, according to one example.

FIG. 6 is a flow chart showing a method of generating a learning model that determines factor information indicating a factor by which emotion information is obtained, based on results of learning reference scenes and emotion information of a plurality of users about reference scenes, according to one example.

FIG. 7 is a diagram schematically illustrating an artificial neural network that learns reference scenes and emotion information of a plurality of users about reference scenes.

FIG. 8 is a diagram for describing a process of obtaining factor information showing a factor by which emotion information about a scene in which emotion information of a user is inputted is obtained using the learning model described in FIG. 6, according to one example.

FIG. 9 is a diagram showing a method of generating a learning model that predicts an interest scene of a certain user in a certain content and emotion information about the interest scene, based on results of learning reference scenes and emotion information of a plurality of users about reference scenes, according to one example.

FIG. 10 is a diagram for describing a process of predicting an interest scene of a user in a novel content and emotion information about the interest scene using the learning model described in FIG. 9, according to one example.

FIG. 11A is a diagram showing an additional service provided based on a scene in which a user leaves emotion information, according to one example.

FIG. 11B is a diagram for describing a content corresponding to a thumbnail selected by a user, according to one example.

FIG. 11C is a diagram for describing a process in which a content is played differently, depending on settings of emotion information, according to one example.

FIG. 12 is a flow chart showing a method of classifying a plurality of users into a plurality of groups, and providing a curation service for each group, according to one example.

FIG. 13 is a block diagram showing the configuration of a server, according to one example.

FIG. 14 is a flow chart showing an operating method of an electronic device that provides an additional service based on emotion information of a user about a scene in a content, according to one example.

FIG. 15 is a block diagram illustrating the configuration of an electronic device according to one example.

### BEST MODE

Hereinafter, various examples will be described in detail with reference to drawings. The examples described below may be modified and implemented in various different forms. Hereinafter, key terms will be defined for a better understanding. A “scene” may refer to a logical unit of content, such as a segment between two cuts or a segment featuring a specific character. A “learning model” may comprise a Convolutional Neural Network (CNN) for visual features and a Recurrent Neural Network (RNN) for textual data. The term “emotion data packet” refers to a unit of data transmitted from the electronic device, comprising at least a timestamp indicating the precise playback time of an emotional input.

The user's emotional input, and thus the emotion data packet, may further comprise data representing the intensity of the emotion. For example, the user interface may be configured to distinguish between a short tap on an emoticon (indicating a standard level of emotion) and a long press (indicating a high level of emotion). This intensity data provides a richer, more nuanced layer to the emotion data packet, allowing the learning model to make more accurate predictions.

The “additional content” generated by the server is a “new media asset,” which is a manageable unit of media separate from the original content.

In one embodiment, the additional content can be delivered as “bookmark information.” In this case, the server transmits a list of timestamps to the electronic device. The client-side player then sequentially seeks to these timestamps within the original content. While this method is efficient in terms of server storage, it may result in a non-seamless playback experience with potential buffering or lag between scenes, as the player has to re-buffer at each seek point. The user interface, such as the playback bar, would also remain tied to the timeline of the original content, which can be confusing.

In another embodiment, to overcome the limitations of the bookmark method, the additional content is generated as a “new media asset.” This refers to a manageable unit of media, separate from the original content, that provides a seamless playback experience. This new media asset can be: (i) A single, self-contained media file (e.g., an MP4 file) created by stitching the relevant scene segments together. (ii) In an adaptive streaming environment, a combination of a manifest file (e.g., a .m3u8 playlist) and the plurality of media segments referenced therein. This manifest file defines a new, continuous playback sequence of existing segments, allowing for seamless transitions without re-buffering and providing an independent timeline for the user.

In one embodiment, the new media asset is a single, self-contained media file (e.g., an MP4 file) created by stitching segments together.

In another embodiment, particularly in an adaptive streaming environment, the new media asset comprises a combination of a manifest file (e.g., a .m3u8 playlist) and the plurality of media segments referenced therein. In this case, the manifest file defines a new playback sequence of existing segments from the original content, and this combination of the manifest and its referenced segments constitutes the complete, playable media asset.

In yet another embodiment, the “additional content” may be a pre-existing media asset that is selected from a library of pre-generated contents. In this case, the server does not generate a new media asset on-the-fly. Instead, it analyzes the user's emotion information to identify a pre-generated highlight clip (e.g., “Funniest Moments of Season 1”) that best matches the user's emotional preferences. The server then provides an access path to this selected, pre-existing media asset. This embodiment is particularly useful for popular content where common points of interest can be pre-compiled to reduce server load.

An “access path” (e.g., a URL) is provided to the electronic device to stream this new media asset, allowing access without manual seeking operations.

In order to describe the characteristics of the examples more clearly, detailed description of matters widely known to those skilled in the art to which the following examples belong will be omitted.

On the other hand, in the present description, when a certain configuration is said to be “connected” to another configuration, this includes not only cases of being ‘directly connected’, but also cases of being ‘connected with another configuration in between’. In addition, when a certain configuration “comprises” another configuration, this means that, unless specifically stated to the contrary, other configurations are not excluded and another configuration may be further comprised.

In addition, terms including ordinal numbers such as ‘first’ or ‘second’ or the like used in the present description may be used to describe various components, but the component should not be limited by the terms. The terms are used only for the purpose of distinguish one component from another component.

In the present description, “server” may generate an additional content about a scene in which a user expresses emotions while watching a content, and provide an additional service based on a factor by which emotions are expressed or the additional content.

In the present description, “electronic device” may be a smartphone, a tablet PC, a PC, a TV, a smart TV, a mobile phone, a PDA (personal digital assistant), a laptop, or a non-mobile computing device, or the like, but not limited thereto. In the electronic device, an application providing a content service may be distributed and installed. The electronic device may execute an application providing a content service, receive emotion information about a content played through the application, and provide an additional service based on emotion information.

In the present description, “content” may mean information or contents provided through Internet or computer communication or the like. The contents may mean information or contents processed or distributed by digitally creating letters, codes, voices, sounds, images, videos and the like. For example, the content provided through the server may be a video. “Additional content” may mean a content provided by additionally generating one other than the content basically provided on a platform that provides a content service.

In the present description, “emotion information” of a user may mean information showing emotional state of a user. The emotional state may represent joy, like, dislike, sympathy, sadness, anger, fear, and the like, but it is not limited to the above examples.

In the present description, “additional service” is an additionally provided service in addition to a basically provided service on a platform that provides a content service, and may be provided by being customized for each user. For example, the additional service may include a service that stores or manages a generated additional content in a storage space of a user, a service that watches an additional content, a service that recommends an additional content or a content related to the additional content, and the like. For example, the content related to the additional content may be related to the additional content, among basically provided contents on a platform that provides a content service. For example, the additional content may be a collection about a scene in which a user expresses joy. In this case, the content related to the additional content may be a video about a comic genre. In addition, the additional service may be provided by being customized to an individual of a user, and may be provided by being customized to a group to which the user belongs.

For example, an additional service based on a content may be an additional service for a content of a scene in which a user leaves an emotional state or a content belonging to attributes similar to the content. Herein, the similar attributes may be determined based on preset criteria for items such as the genre of the content, characters appearing in the content, background, music and the like.

For example, the additional service based on the content may comprise a curation service for an additional content and at least one content related to the content. The curation service may refer to a service that distributes a content classified according to interest information of a user or a group to which the user belongs.

In alternative embodiments, the user's emotion information can be obtained through various technical means beyond emoticons, including analysis of a user's voice signal, biometric signals from a wearable device, or recognition of facial expressions via a camera.

Furthermore, the collected emotion data can be leveraged for other valuable services. In another embodiment, the server may analyze the data to generate a content analysis report for content creators, providing insights into audience engagement. Additionally, the server may provide a service for emotion-based targeted advertising, where advertisements are presented to a user based on the emotional state they have expressed.

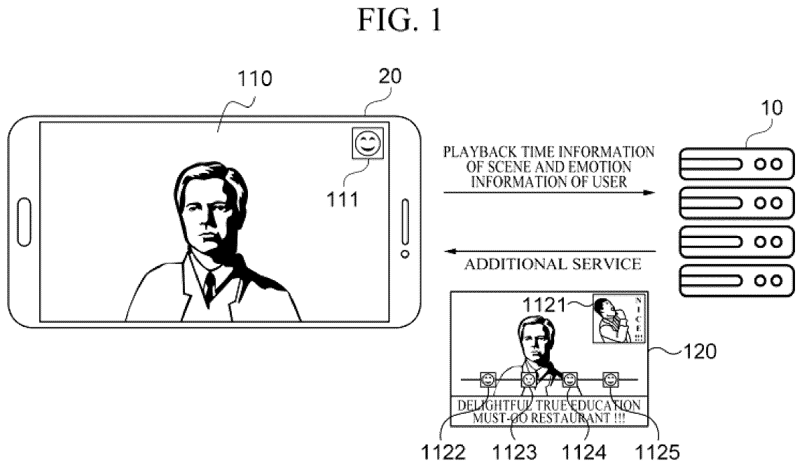

FIG. 1 is a conceptual diagram for explaining operation of an electronic device 20 and a server 10 that provide an additional service based on a scene in which a user expresses emotions while watching a content, according to one example.

Referring to FIG. 1, a user may execute an application providing a content service in an electronic device 20, and play a content of interest. The electronic device 20 may provide a user interface through which an emotional state of a user can be inputted on a playback screen of a content. While the content is being played, the user may express emotions about scenes of the content. For example, when the user feels a delightful feeling in the scene 110 on the content, the user may input emotion information with an emotion emoticon indicating the delightful feeling. A mark (111) corresponding to emotion information may be displayed in the scene 110 on the content. The electronic device 20 may transmit playback time information of the scene 110 in which the user expresses emotions and emotion information of the user to a server 10.

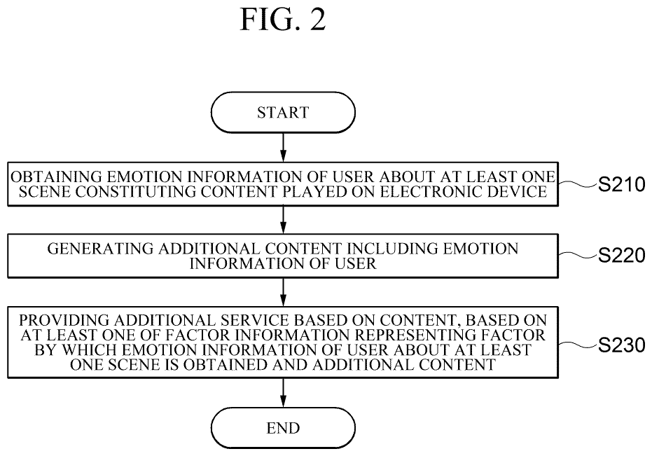

The server 10 may receive playback time information of the scene 110 in which the user expresses emotions and emotion information of the user from the electronic device 20 and generate an additional content 120 including emotion information. The server 10 may provide an additional service to the electronic device 20, based on the additional content 120. More detailed contents are described in FIG. 2 to FIG. 15.

FIG. 2 is a flow chart showing an operation method of a server 10 that provides an additional service based on emotion information of a user about a scene in a content obtained from an electronic device 20.

Referring to FIG. 2, in the step S210, the server 10 may obtain emotion information of a user about at least one scene constituting a content played in the electronic device 20. Specifically, the server 10 may receive one or more emotion data packets from the electronic device 20. Each packet may include data representing the type of emotion and, importantly, a timestamp indicating the precise playback time within the content when the user's input was made.

Herein, the emotion information may be information indicating emotional states such as joy, like, dislike, sympathy, sadness, anger, fear and the like. The examples of the emotional states are not limited to the above examples, and states representing various emotions may be included.

For example, the server 10 may receive emotion information of the user about the entire scene constituting the content or a part of the scene, based on the preset emotion emoticon from the electronic device 20. The preset emotion emoticon may be a user interface for expressing the emotional state of the user. In addition, the user may have a plurality of profiles, and expression of the emotion emoticon may be limited for each episode in the content per profile. The server 10 may receive emotion information about a scene in which a user leaves an emotional state while watching a content.

Moreover, the server 10 may obtain playback time information of the scene in which the user leaves the emotional state together with the emotion information of the user about the scene.

In the step S220, the server 10 may generate an additional content including the emotion information of the user. As defined previously, this additional content is created as a new media asset, which is separate and distinct from the original content. The server may process the received timestamps to identify corresponding scene segments from the original content and combines them into this new media asset. The additional content may be generated based on the scene in which the user leaves the emotional state and the emotion information of the user about the scene. For example, the server 10 may generate a clip video based on the scene in which the user leaves the emotional state. For example, the clip video may be a video edited in a preset time unit by extracting the scene in which the user leaves the emotional state. For example, the preset time unit may be 3 minutes˜5 minutes. For example, the clip video may include the scene in which the user leaves the emotional state and scenes of before and after time based on the playback time of the scene in which the user leaves the emotional state. Herein, the before and after time may be determined as a preset time, or may be determined based on the story in the scene.

Furthermore, the additional content may be a content for providing a replay about the scene in which the user leaves the emotional state. For example, the replay may be an operation of rewatching at least a part of content with history that the user has watched. For example, the form of the content for providing a replay may be provided as videos, images, or the like. The server 10 may generate an additional content, for each same content. In addition, the server 10 may generate an additional content depending on emotion information of a user, in the same content. In other words, the server 10 may generate an additional content based on scenes classified into the same emotion information.

In the step S230, the server 10 may provide an additional service based on the content into the electronic device 20, based on at least one of factor information representing a factor by which emotion information of a user about at least one scene is obtained and an additional content.

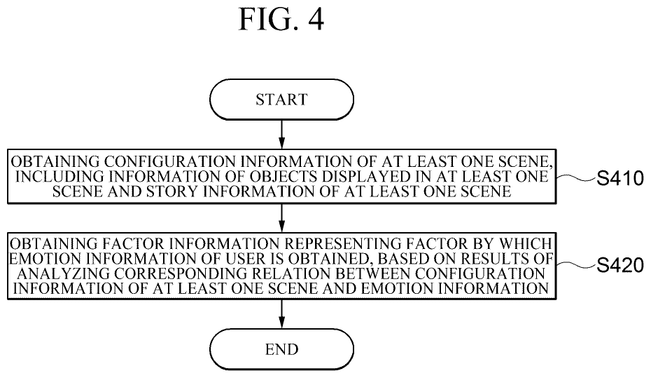

For example, the server 10 may transmit an access path (e.g., a URL or a unique identifier) for the newly generated media asset to the electronic device 20. When the user select a thumbnail corresponding to the additional content, the electronic device may use this access path to request and stream the new media asset. This process may allow the user to directly access scenes of interest without performing manual seeking operations on the original content, which in turn reduces unnecessary data processing on the server. For example, the server 10 may provide an additional content about the scene in which the user leaves the emotional state into the electronic device 20. In addition, the server 10 may obtain factor information indicating a cause in which the user leaves the emotional state about the scene of the content. The process of obtaining factor information in the server 10, specifically, is described in FIG. 4 to FIG. 8.

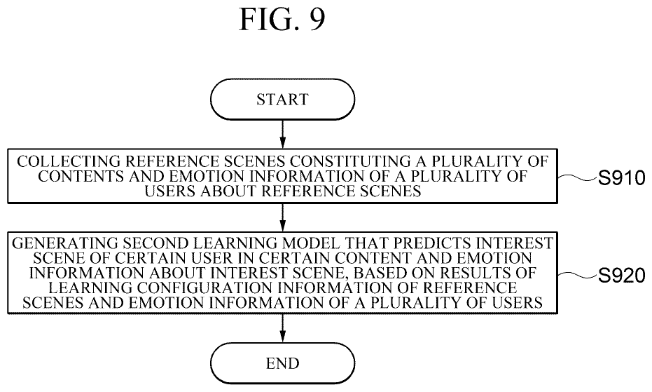

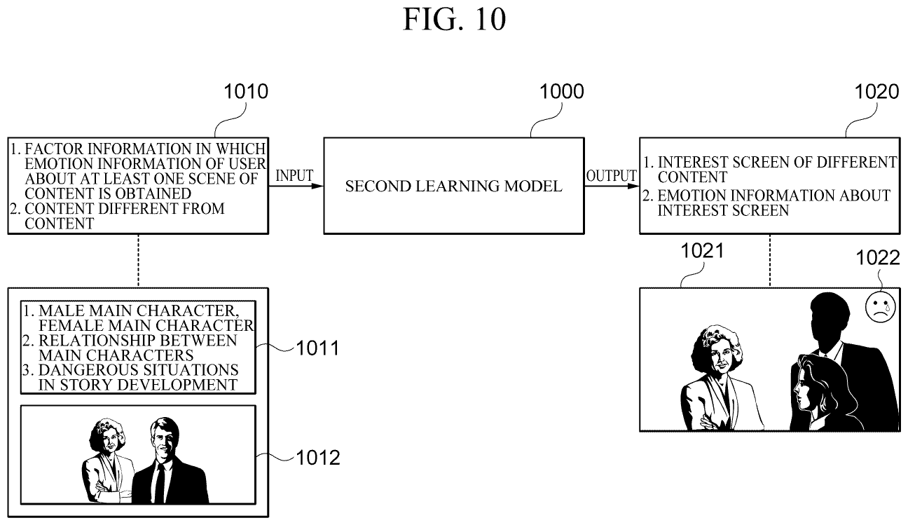

For example, the server 10 may provide an additional service for a second content different from a first content used for determining factor information based on factor information into the electronic device 20. For example, the second content may be a content belonging to attributes similar to the first content used for determining factor information. In addition, the second content may be a content with no history that the user has watched. The server 10 may determine an interest scene of the second content, and generate an additional content related to the interest scene, based on factor information and information of the second content. Based on the factor information of the first content and information of the second content, the operation of the server 10 that determines the interest scene of the second content is described in FIG. 9 to FIG. 10.

For example, the server 10 may provide an additional content into the electronic device 20, when an input for selecting a thumbnail of the additional content is obtained from the electronic device 20. Specifically, the electronic device 20 may display a thumbnail list of the additional content, and receive an input for selecting a first thumbnail in the thumbnail list. The server 10 may provide a service so that an additional content corresponding to the first thumbnail can be played in the electronic device 20, when an input for selecting the first thumbnail is obtained from the electronic device 20.

Furthermore, the server 10 may provide the playback time of at least one scene by displaying it on a search bar while the content is being played. The search bar may be displayed on the scene in which the content is played, and information of the playback time may be displayed. In addition, in the search bar, an icon that can adjust the playback time may be provided. The server 10 may display the playback time of the scene in which the user leaves the emotional state on the search bar.

For example, the server 10 may provide a preview of a content having no playback history, based on factor information indicating a factor by which emotion information of a user about at least one scene of a content. The server 10 may obtain factor information indicating a cause in which the user leaves the emotion information about the scene. The server 10 may generate an additional content for the content having no playback history of the user, and provide the generated additional content as a preview.

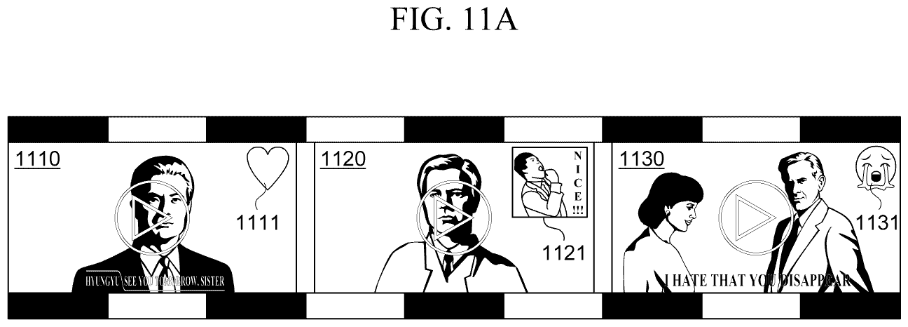

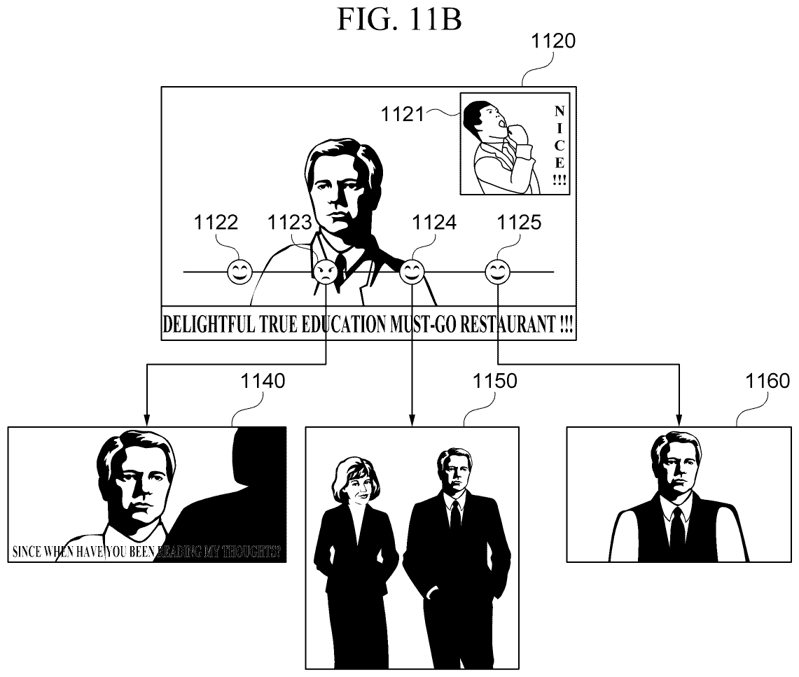

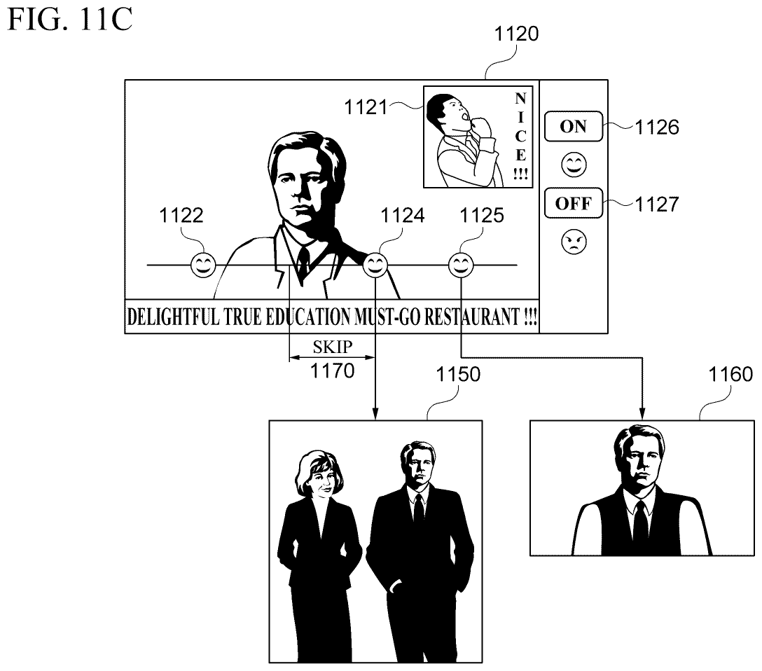

In the server 10, the example of the additional service provided into the electronic device 20 is described in FIG. 11A to FIG. 11C.

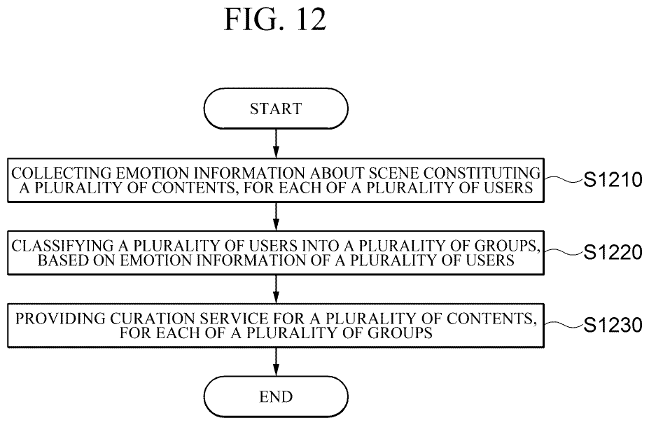

On the other hand, the server 10 may classify a plurality of users of a platform providing a service of a content according to preset criteria, and provide a curation service for the content, for each classified group. The operation of the server 10 providing the curation service for each group is described in FIG. 12.

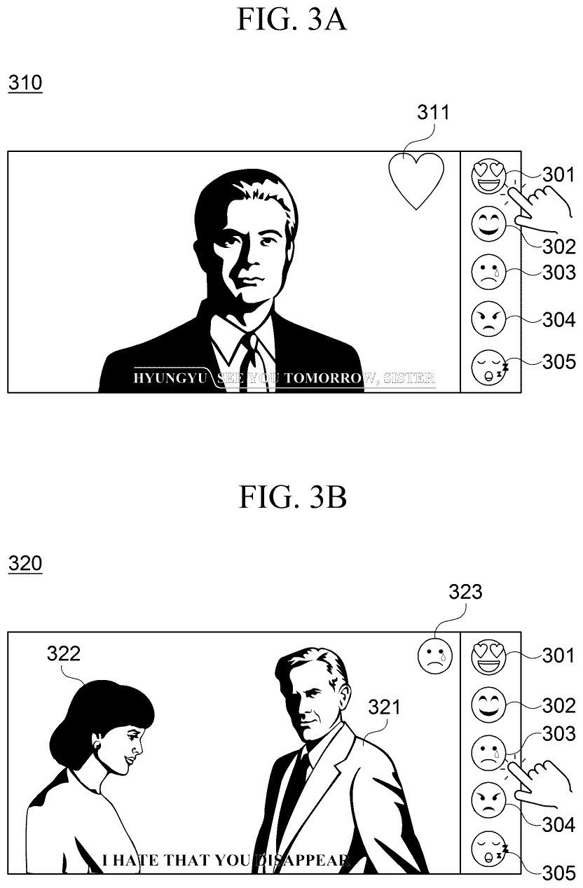

FIG. 3A and FIG. 3B are diagrams for describing a process of obtaining emotion information of a user about one scene constituting a content played on an electronic device 20, according to one example.

The electronic device 20 may execute an application providing a service of a content according to an input of a user. The user may play a content of interest through the application. The user may input emotion information indicating the emotional state on a scene in which the emotional state of the user is to be expressed, while the user watches the content.

Referring to the image 310 of FIG. 3A, the electronic device 20 may play a content, and display a user interface through which emotion information can be inputted on a part of the scene. The user interface may be displayed as overlapped on the scene of the content. In addition, the user interface may be displayed in an outer region of a region in which the scene of the content is displayed.

For example, the user interface may be preset emotion emoticons 301, 302, 303, 304, 305. Since it is inconvenient for the user to input emotion information through text or the like while watching a content, the user interface may be implemented with emotion emoticons representing the emotional state of the user. For example, the emotion emoticons representing the emotional state may include a fluttering emoticon 301, a joy emoticon 302, a sad emoticon 303, an angry emoticon 304 and a bored emoticon 305. The emotion emoticons illustrated in FIG. 3A are one example, and emoticons representing other emotional states may be displayed.

As illustrated in FIG. 3A, the user may input the fluttering emoticon 301 while watching a content. When an input for selecting the fluttering emoticon 301 is received, the electronic device 20 may display a mark 311 representing fluttering on the scene of the content. In addition, the electronic device 20 may display emotion information which users who watched the content leave. For example, the electronic device 20 may display a mark representing emotion information which users leave most on the scene of the content.

Referring to the image 320 of FIG. 3B, a plurality of characters may appear in the scene of the content. In this case, the user may input an emotional state about the entire scene, or input an emotional state for each object in the scene which is a part of the scene.

As illustrated in FIG. 3B, the user may input a sad emoticon 303 while watching a content. In this case, the user may input emotion information for each of a first character 321 and a second character 322. When an input for selecting the sad emoticon 303 is received, the electronic device 20 may display a mark 323 representing sadness on the scene of the content. On the other hand, when the emotion information of the user is inputted for each object in the scene, the server 10 may accurately obtain factor information representing a cause in which the user expresses emotions.

FIG. 4 is a flow chart showing a method of obtaining factor information showing a factor by which emotion information of a user about a scene is obtained, according to one example.

Referring to FIG. 4, in the step S410, the server 10 may obtain configuration information of at least one scene in which a user leaves emotion information. The configuration information may refer to information of an object constituting a scene. For example, the configuration information of at least one scene may include information of objects displayed on at least one scene constituting a content and story information of at least one scene. For example, the object displayed in the scene may be characters, background, items, or the like. In addition, the object may be an OST output during playing of the content. Moreover, the story information may be information about the plot, summary, character relationship chart, dialogue, and the like of the content.

The server 10 may detect a specific scene in the content, based on the playback time in which the emotion information is inputted. The server 10 may obtain information of objects displayed in a specific scene, based on the specific scene, and obtain story information of the specific scene based on dialogue or subtitles.

In the step S420, the server 10 may obtain factor information indicating a factor by which the emotion information of the user is obtained, based on results of analyzing the corresponding relationship between the configuration information and emotion information of at least one scene. In other words, the server 10 may obtain factor information representing a cause in which the user leaves emotion information about the scene while watching the content. The factor information may be used for selecting a certain content for providing an additional service to the user and an interest scene in a certain content.

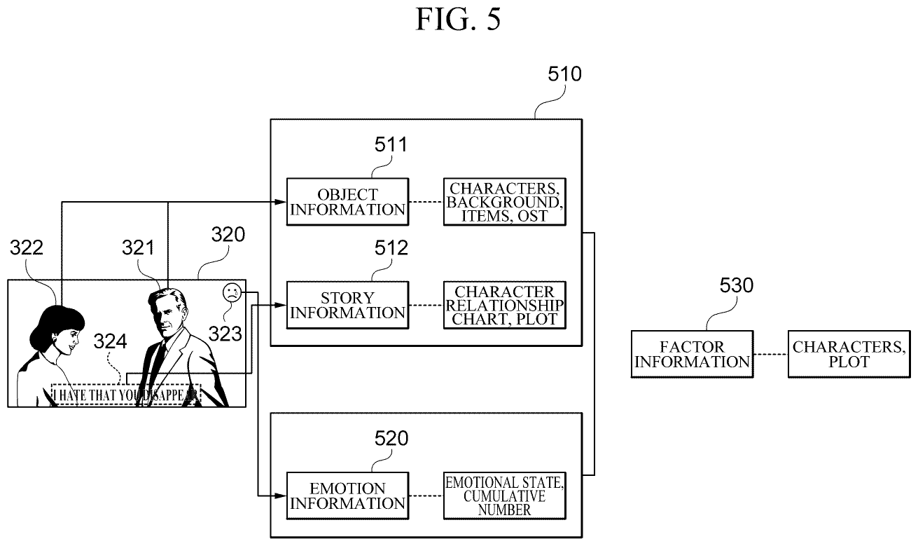

FIG. 5 is a diagram for describing a process of obtaining factor information showing a factor by which emotion information about a scene in which emotion information of a user is inputted is obtained, according to one example.

Referring to FIG. 5, the server 10 may obtain playback time information in which sadness information is inputted in the first content, and detect a first scene 320 in the first content. The server 10 may obtain configuration information 510 of the first scene 320. For example, the configuration information 510 of the first scene 320 may include object information 511 and story information 512. The object information 511 may include information such as characters appearing in the scene, background, items, OST and the like. In addition, the story information 512 may include information for the plot, summary, character relationship chart, dialogue, subtitles and the like of the content. Moreover, the server 10 may obtain emotion information 520 of the user about the first scene 320. The emotion information 520 may include the emotional state, cumulative number of inputted emotions and the like. For example, the cumulative number of the inputted emotions may be a number expressed by accumulating specific emotions about a specific scene.

Specifically, the server 10 may obtain the first character 321 and the second character 322 appearing in the first scene as object information 511. In addition, the server 10 may obtain subtitles 324 displayed in the first scene as story information 512. Moreover, the server 10 may obtain sadness information 323 as emotion information 520.

The server 10 may determine that it is a situation in which the first character 321 and the second character 322 may be separated, based on the object information 511 and story information 512 of the first scene 320. The server 10 may analyze the corresponding relation between the situation of the first scene and emotion information 520, and determine factor information indicating a factor in which the user leaves sadness information 323. The factor information may be detailed items used for determining the situation of the first scene. For example, the factor information 530 of the first scene may be information of the characters appearing in the first scene, plot, subtitles and the like.

In other words, the server 10 may determine which factor caused the user to leave the emotional state in a certain scene of the content, by analyzing the corresponding relation between the configuration information of the scene in which the user leaves emotion information and the emotion information.

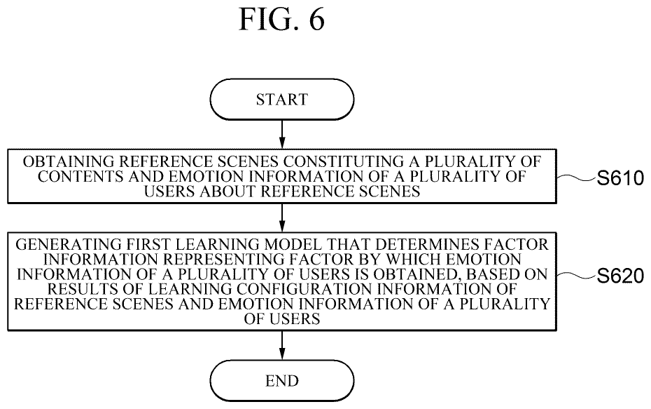

FIG. 6 is a flow chart showing a method of generating a learning model that determines factor information indicating a factor by which emotion information is obtained, based on results of learning reference scenes and emotion information of a plurality of users about reference scenes, according to one example.

Referring to FIG. 6, in the step S610, the server 10 may obtain reference scenes constituting a plurality of contents and emotion information of a plurality of users about the reference scenes.

Specifically, the server 10 may obtain scenes in which users leave emotional states for each content as reference scenes. In addition, the server 10 may obtain emotion information of a plurality of users about the reference scenes. The server 10 may map each reference scene and emotion information of the user and store them as learning data.

In the step S620, the server 10 may generate a first learning model that determines factor information indicating a factor by which emotion information of a plurality of users is obtained, based on results of learning the configuration information of the reference scenes and emotion information of a plurality of users.

Specifically, the server 10 may obtain the information of objects for the reference information and story information as the configuration information of the reference scenes. The server 10 may learn the corresponding relation between the configuration information about the reference scenes and emotion information of a plurality of users. The server 10 may generate the first learning model that determines factor information indicating a cause in which a plurality of users leave emotional states about the reference scenes, based on the results of learning the corresponding relation.

For example, the first learning model may receive an input of at least one scene and the emotion information of the user about at least one scene as input values. The first learning model may output factor information indicating a factor by which the emotion information of the user about at least one scene is obtained as output values, as the input values are inputted.

Therefore, when the screen in which the user leaves the emotional state and emotion information indicating the emotional state of the user are applied to the first learning model, the first learning model may determine by what factor the user expressed emotions on the screen of the content. The server 10 may determine a content to be recommended to the user and provide an additional service for the content to be recommended.

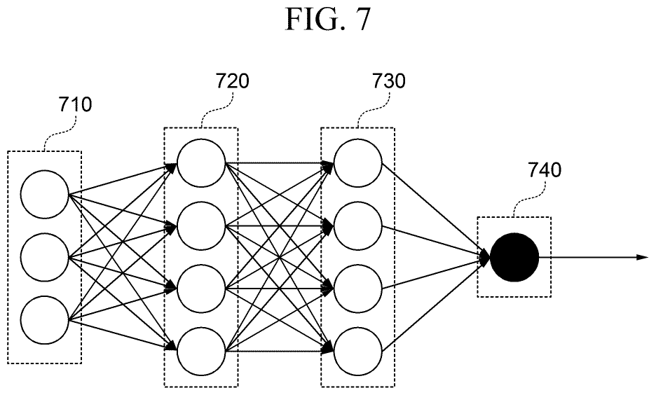

FIG. 7 is a diagram schematically illustrating an artificial neural network that learns reference scenes and emotion information of a plurality of users about reference scenes.

Referring to FIG. 7, an artificial neural network may include an input layer 710, at least one hidden layer 720, 730 and an output layer 740. In addition, calculations through the artificial neural network may be performed in a processor in the server 10.

In addition, weighted values between each layer and node may be learned through learning and training performed in the hidden layer 720, 730. For example, the server 10 may generate the first learning model that determines factor information indicating a cause in which a plurality of users leave emotional states about reference scenes, by repeatedly learning the corresponding relation between the configuration information about reference scenes and emotion information of a plurality of users.

Furthermore, the server 10 may obtain values of the weighted values of parameters that affect generating the first learning model which determines factor information indicating a factor by which the emotion information of the user about a certain scene is derived. The server 10 may relearn the first learning model by applying the values of the weighted values obtained from the trained artificial neural network. By relearning the first learning model to which the values of the weighted values are applied, the first learning model may accurately determine factor information indicating a factor by which the emotion information of the user about a certain scene is derived.

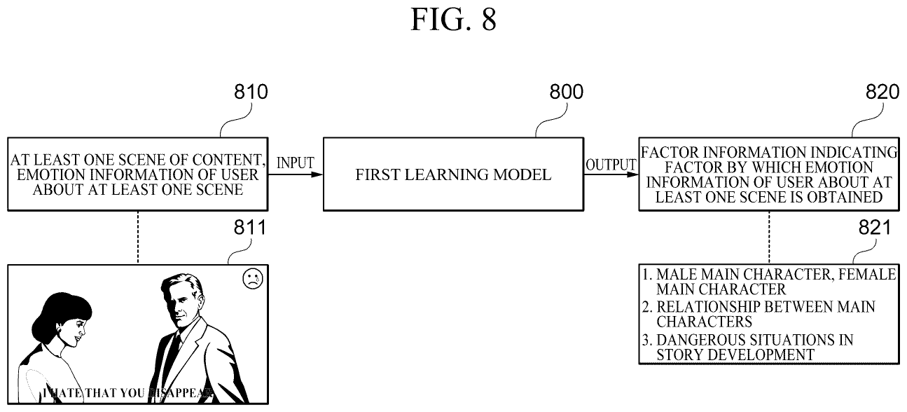

FIG. 8 is a diagram for describing a process of obtaining factor information showing a factor by which emotion information about a scene in which emotion information of a user is inputted is obtained using the learning model described in FIG. 6, according to one example.

Referring to FIG. 8, the first learning model 800may obtain at least one scene of a content and emotion information of a user about at least one scene as input data 810. For example, the server 10 may receive playback time information of a content in which an emotional state of a user is inputted from the electronic device 20 and emotion information indicating the emotional state of the suer. The server 10 may detect the scene 811 of the content, based on the playback time information of the content. The server 10 may obtain the scene 811of the content and emotion information that leaves a sadness state in the scene 811 as input data 810 of the first learning model 800.

The first learning model 800 may obtain factor information indicating a factor by which the emotion information of the user about at least one scene is obtained, as output data 820, as the input data 810 is inputted. For example, the output data 820 may represent factor information indicating a factor by which the user leaves sadness information about the scene 811. Specifically, the output data 820 may represent information 821 of a male main character, a female main character, relationship between main characters, and dangerous situations in the story development and the like.

FIG. 9 is a diagram showing a method of generating a learning model that predicts an interest scene of a certain user in a certain content and emotion information about the interest scene, based on results of learning reference scenes and emotion information of a plurality of users about reference scenes, according to one example.

Referring to FIG. 9, in the step S910, the server 10 may collect reference scenes constituting a plurality of contents and emotion information of a plurality of users about the reference scenes.

Specifically, the server 10 may obtain scenes in which users leave emotional states for each content as reference scenes. In addition, the server 10 may obtain emotion information of a plurality of users about the reference scenes. The server 10 may map and each reference scene and emotion information of the user and store them as learning data.

In the step S920, the server 10 may generate a second learning model that predicts an interest scene of a certain user in a certain content and emotion information about the interest scene, based on results of learning the configuration information of the reference scenes and the emotion information of a plurality of users.

Specifically, the server 10 may obtain the information of objects about the reference scenes and story information as the configuration information of the reference scenes. The server 10 may learn the corresponding relation between the configuration information about the reference scenes and emotion information of a plurality of users. The server 10 may generate the second learning model that predicts a n interest scene of a certain user in a certain content and emotion information about the interest scene, based on results of learning the corresponding relation.

On the other hand, the structure of the artificial neural network used for generation of the second learning model may be same as the structure of the artificial neural network described in FIG. 7. The server 10 may generate the second learning model that predicts an interest scene satisfying the corresponding relation learned in a certain content and emotion information about the interest scene, by repeatedly learning the corresponding relation between the configuration information about reference scenes and emotion information of a plurality of users.

In addition, the server 10 may obtain values of weighted values of parameters that have an influence on generating the second learning model that predicts an interest scene of a certain content and emotion information of the interest scene. The server 10 may relearn the second learning model by applying values of weighted values obtained in the trained artificial neural network. By relearning the second learning model in which the values of the weighted values are applied, the second learning model may accurately predict an interest scene of a certain content and emotion information of the interest scene.

For example, the second learning model may receive an input of factor information indicating a factor by which emotion information of a user about at least one scene constituting a content is obtained and information of a content different from the content as input values. The second learning model may predict at least one interest scene of a user and emotion information about at least one interest scene in the different content and output them as output values. Herein, the factor information indicating a factor by which the emotion information of the user about the scene is obtained, may be obtained from the output values of the first learning model described in FIG. 6 to FIG. 8.

Therefore, when factor information indicating a factor by which the emotion information of the user about the scene of the first content is obtained and information of the second content are applied to the second learning model, the second learning model may predict and output an interest screen of the second content and emotion information of the interest screen. The server 10 may provide an additional service about a content to be recommended to a user, based on information outputted from the second learning model.

The learning models, such as the first and second learning models, are not static. They are configured to be part of a continuous retraining and enhancement cycle. As the server accumulates new emotion data packets from a plurality of users over time, this new data is periodically used as a new training set to retrain or fine-tune the existing learning models. The updated, more accurate models are then deployed back into the service, resulting in improved performance for factor information determination and new content prediction. This creates a self-improving system where the service quality and personalization accuracy enhance as more users interact with the content, establishing a powerful network effect that is difficult for competitors to replicate.

FIG. 10 is a diagram for describing a process of predicting an interest scene of a user in a novel content and emotion information about the interest scene using the learning model described in FIG. 9, according to one example.

Referring to FIG. 10, the second learning model 1000 may obtain factor information indicating a factor by which emotion information of a user about at least one scene constituting a content is obtained and information of a content different from the content as input data 1010.

For example, the factor information indicating a factor by which the emotion information of the user about at least one scene is obtained may be obtained as output data of the first learning model 800. In addition, the content different from the content may be a content to be recommended to the user. For example, the content to be recommended may be a content having attributes similar to the content watched by the user. The similar attributes may be determined with preset criteria for items such as the genre of the content, characters appearing in the content, background, music and the like.

The server 10 may obtain information 1011 of a male main character, a female main character, relationship between main characters, and dangerous situations in the story development and the like of the first content and information 1012 of the second content different from the first content as input data 1010.

The second learning model 1000 may obtain an interest screen of a content different from the content and emotion information of a user about the interest screen, as input data 1010 is inputted, as output data 1020. For example, the output data 1020 may represent an interest screen 1021 of the second content different from the first content and the emotion information 1022 of the user about the interest screen 1021.

FIG. 11A is a diagram showing an additional service provided based on a scene in which a user leaves emotion information, according to one example.

The additional service provided based on the scene in which the user leaves emotion information, may be an additional service for the content of the scene in which the user leaves an emotional state or a content belonging to attributes similar to the content. In addition, the additional service may include a curation service for an additional content and at least one content related to the content.

The user may input emotion information indicating the emotional state in the scene in which the emotional state of the user is expressed, while watching the content. The server 10 may receive playback time information of the content in which the emotional state of the user is inputted and emotion information indicating the emotional state of the user from the electronic device 20. The server 10 may obtain the scene of the content, based on the playback time information of the content The server 10 may generate an additional content including the emotional state of the user. The server 10 may provide a curation service based on an additional content to the electronic device 20. For example, the additional content may be a video in which the emotion information of the user about at least one scene is displayed. The user may enter my menu of the user and confirm the additional content.

Referring to FIG. 11A, the electronic device 20 may be provided a thumbnail list of the additional content from the server 10 and display a thumbnail list. Herein, the additional content may be generated based on the scene in which the user leaves emotion information, or be generated from a content to be recommended to the user. For example, the thumbnail list may include a thumbnail 1110 of a first additional content, a thumbnail 1120 of a second additional content and a thumbnail 1130 of a third additional content. In each thumbnail 1110, 1120, 1130, marks 1111, 1121, 1131 representing the emotion information of the user may be displayed.

On the other hand, the content corresponding to the thumbnail in the thumbnail list may include not only a content in the screen in which the user leaves emotions, but also a content recommended to the user based on the screen in which the emotions are left.

FIG. 11B is a diagram for describing a content corresponding to a thumbnail selected by a user, according to one example.

In the thumbnail list indicated in FIG. 11A, when the thumbnail 1120 of the second additional content is selected, as illustrated in FIG. 11B, the electronic device 20 may play the second additional content. Herein, the second additional content may be a content generated based on the scenes in which the user leaves emotions in the second content. The second additional content may be a collection of clip videos generated based on the scene in which the user leaves emotions.

For example, the second additional content may include a first clip video generated based on a first scene of the second content, a second clip video 1140 generated based on a second scene of the second content, a third clip video 1150 generated based on a third scene of the second content, and a fourth clip video 1160 generated based on a fourth scene of the second content.

For example, the electronic device 20 may display a search bar in a playback screen of the second additional content. The search bar may be displayed in the playback screen according to the touch input. In a state in which the search bar is displayed in the playback screen, when the touch input is received, the search bar may disappear from the playback screen.

For example, in the search bar, the playback time 1122 of the first clip video, the playback time 1123 of the second clip video 1140, the playback time 1124 of the third clip video, and the playback time 1125 of the fourth clip video may be displayed. In this case, each playback time 1122, 1123, 1124, 1125 may be displayed with emoticons indicating the emotion information that the user leaves in the screen of each clip video. In addition, the electronic device 20 may display a mark 1121 indicating the emotional state which the user leaves on the playback screen of the second additional content.

In FIG. 11B, it is described that the search bar is displayed in the additional content, but the search bar may be displayed also in the content. For example, during playing the first content, the search bar may be displayed in the bottom part of the screen of the first content, and in the search bar, the playback time corresponding to time at which the user leaves emotion information may be displayed. Moreover, during playing the first content, in the screen in which the user leaves emotion information in the first content, the emotion information of the user may be displayed. In other words, a mark indicating the emotional state which the user leaves in the screen in which the user leaves emotion information may be displayed.

FIG. 11C is a diagram for describing a process in which a content is played differently, depending on settings of emotion information, according to one example.

Referring to FIG. 11B again, the emotion information of the user about the first clip video, the third clip video 1150 and the fourth clip video 1160 may represent delightfulness, and the emotion information of the user about the second clip video 1140 may represent anger.

Referring to FIG. 11C, the electronic device 20 may control playback of clip vides for each emotion information of the user. For example, the user may arrange emoticons representing delightfulness in ON item 1126, and arrange emoticons representing anger in OFF item 1127. The electronic device 20 may control playback of the additional content, according to arrangement of the emoticons representing emotion information. Specifically, the emoticons indicating playback time 1123 of the second clip video 1140 may disappear from the search bar. The electronic device 20 may skip playing of the second clip video 1140 after playing the first clip video, and sequentially play the third clip video 1150 and the fourth clip video 1160. In the search bar, the section 1170 indicates a skip section of the second clip video 1140.

FIG. 12 is a flow chart showing a method of classifying a plurality of users into a plurality of groups, and providing a curation service for each group, according to one example.

Referring to FIG. 12, in the step S1210, the server 10 may collect emotion information about a scene constituting a plurality of contents, for each of a plurality of users. For example, the server 10 may collect the scene in which the user leaves the emotional state and the emotion information of the user about the scene, for each of a plurality of users.

In the step S1220, the server 10 may classify a plurality of users into a plurality of groups, based on the emotion information of a plurality of users. For example, the server 10 may classify a plurality of users into a plurality of groups, based on the number that a scene of a certain content and emotion information of the scene are same between the users.

In the step S1230, the server 10 may provide a curation service about a plurality of contents, for each of a plurality of groups.

In addition, the server 10 may provide a space in which communication can be performed with members in the group, for each of a plurality of groups. The space in which communication can be performed, may refer to a space in which text chatting, video call and the like can be conducted between the members.

More specifically, this “space” refers to a specific technical implementation of a user interface and a backend system provided by the server, which is designed to facilitate interaction among members. This is not an abstract concept but a concrete digital environment. For example, this “space” can be implemented as: (i) a dedicated user interface page within the OTT application accessible only to group members; (ii) a real-time chat service (i.e., a chatroom) where members can exchange text messages; or (iii) a message board or forum where members can post comments. The server manages user authentication for the group and stores the communication data generated within this space.

Furthermore, the server 10 may provide a thumbnail list of an interest scene, for each of a plurality of groups. The thumbnail list may include thumbnails representing high ranking scenes selected according to preset criteria.

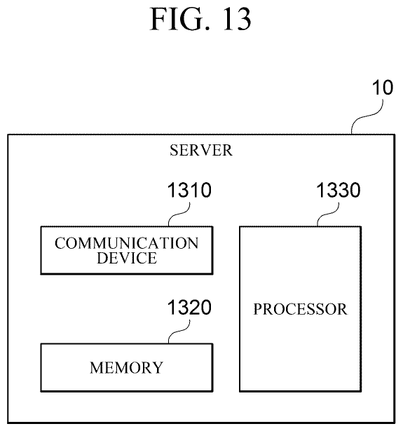

FIG. 13 is a block diagram showing the configuration of a server 10, according to one example.

Referring to FIG. 13, the server 10 may include a communication device 1310, a memory 1320 and a processor 1330. However, all the illustrated components are not essential components. The server 10 may be implemented by more components than the illustrated components, and the server 10 may be implemented even by components less than them. Hereinafter, the components will be examined. The server 10 illustrated in FIG. 13 may correspond to the server described in FIG. 1 to FIG. 12 in the same manner.

The communication device 1310 may perform communication with an external device. For example, the communication device 1310 may perform communication with the external device by being connected with a network by wire or wirelessly. Herein, the external device may be the electronic device 20.

The communication device 1310 may include a communication module that supports one of various wired and wireless communication methods. The communication module may be a short-distance communication module, or a wired communication module.

The memory 1320 may store at least one program for executing a method of generating an additional content about a scene in which a user expresses emotions while watching a content, and providing an additional service based on the additional content in the server 10. The at least one program stored in the memory 1320 may be classified into a plurality of modules depending on function.

The processor 1330 may control overall operations of the server 10 and include at least one processor such as CPU and the like. The processor 1330 may include at least one specialized processor corresponding to each function, or be a processor in a form integrated into one.

The processor 1330 may execute a program stored in the memory 1320, or read data or a file stored in the memory 1320, or store a new file in the memory 1320. In addition, the processor may execute instructions stored in the memory 1320.

The processor 1330 may obtain emotion information of a user about at least one scene constituting a content played in the electronic device 20. Herein, the emotion information may be information representing emotional states such as joy, like, dislike, sympathy, sadness, anger, fear and the like.

For example, the processor 1330 may receive the emotion information of the user about the entire scene constituting the content or a part of the scene, based on an emotion emoticon preset from the electronic device, through the communication device 1310. The preset emotion emoticon may be a user interface for express the emotional state of the user. The communication device 1310 may receive emotion information about a scene in which the user leaves the emotional state while watching the content.

In addition, the processor 1330 may obtain playback time information of the scene in which the user leaves the emotional state with the emotion information of the user about the scene.

The processor 1330 may generate an additional content including the emotion information of the user. The additional content may be generated based on the scene in which the user leaves the emotional state and emotion information of the user about the scene. For example, the processor 1330 may generate a clip video based on the scene in which the user leaves the emotional state. For example, the clip video may include the scene in which the user leaves the emotional state and scenes of before and after time based on the playback time of the scene in which the user leaves the emotional state. Herein, the before and after time may be determined as a preset time, or may be determined based on the story in the scene.

Furthermore, the additional content may be a content for providing a replay about the scene in which the user leaves the emotional state. The processor 1330 may generate an additional content, for each same content. In addition, the processor 1330 may generate the additional content depending on the emotion information of the user, in the same content.

The processor 1330 may provide an additional service based on a content into the electronic device 20, based on at least one of factor information representing a factor by which the emotion information of the user about the at least one scene is obtained and the additional content.

For example, the processor 1330 may provide the additional content about the scene of the content in which the user leaves the emotional state into the electronic device 20. In addition, the processor 1330 may obtain factor information representing a cause in which the user leaves the emotional state about the scene of the content.

For example, the processor 1330 may provide an additional service for a second content different from a first content used for determining factor information based on factor information into the electronic device 20. For example, the second content may be a content belonging to attributes similar to the first content used for determining factor information. In addition, the second content may be a content with no history that the user has watched. The processor 1330 may determine an interest scene of the second content and generate an additional content related to the interest scene, based on factor information and information of the second content.

For example, the processor 1330 may provide an additional content into the electronic device 20, when an input for selecting a thumbnail of the additional content from the electronic device 20. The processor 1330 may provide a service so that the additional content corresponding to the first thumbnail can be played in the electronic device 20, when an input for selecting the first thumbnail is obtained from the electronic device 20.

In addition, the processor 1330 may display and provide the playback time of at least one scene in a search bar while a content is played in the electronic device 20. The search bar may be displayed on the scene in which the content is played, and information at the playback time may be displayed. Moreover, in the search bar, an icon that can adjust the playback time may be provided. The processor 1330 may display the playback time of the scene in which the user leaves the emotional state in the search bar.

For example, the processor 1330 may provide a preview of a content having no playback history, based on factor information indicating a factor by which emotion information of a user about at least one scene of a content is obtained. The processor 1330 may obtain factor information indicating a cause in which the user leaves emotion information about the scene. The processor 1330 may generate an additional content about a content having no playback history of the user, based on the factor information, and provide the generated additional content as a preview.

For example, the processor 1330 may classify a plurality of users of a platform providing a service of a content into a plurality of groups according to preset criteria, and provide a curation service for the content, for each of the classified groups.

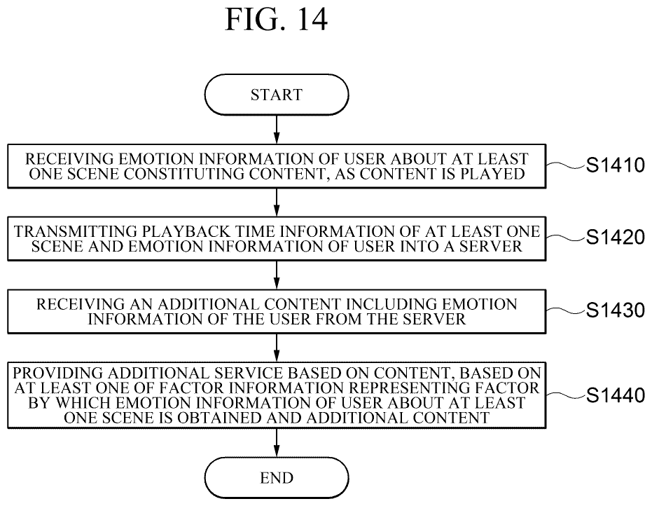

FIG. 14 is a flow chart showing an operating method of an electronic device 20 that provides an additional service based on emotion information of a user about a scene in a content, according to one example.

Referring to FIG. 14, in the step S1410, the electronic device 20 may receive emotion information of a user about at least one scene constituting a content, as the content is played.

For example, the electronic device 20 may receive emotion information of the user about the entire scene constituting the content or a part of the scene, based on the preset emotion emoticon.

In the step S1420, the electronic device 20 may transmit the playback time information of at least one scene and emotion information of the user into the server 10.

In the step S1430, the electronic device 20 may receive an additional content including the emotion information of the user from the server 10.

In the step S1440, the electronic device 20 may provide an additional service based on the content, based on at least one of factor information representing a factor by which the emotion information of the user about at least one scene is obtained and an additional content.

For example, the electronic device 20 may play the additional content, when an input for selecting a thumbnail of the additional content is received. In addition, the electronic device 20 may display the playback time of at least one scene in a search bar while the additional content is played.

For example, the electronic device 20 may provide a preview of a content having no playback history, based on factor information representing a factor in which emotion information of the user about at least one scene of the content is analyzed.

For example, the electronic device 20 may provide a service capable of conducting communication with a member of a group classified as the same group as the user based on factor information representing a factor by which the emotion information of the user about the at least one scene is analyzed.

For example, the electronic device 20 may provide a curation service for a plurality of contents, based on the content watched by the member of the group.

For example, the electronic device 20 may provide a thumbnail list of an interest scene based on the content watched by the member of the group. For example, the thumbnail list may include thumbnails representing high ranking scenes selected according to preset criteria.

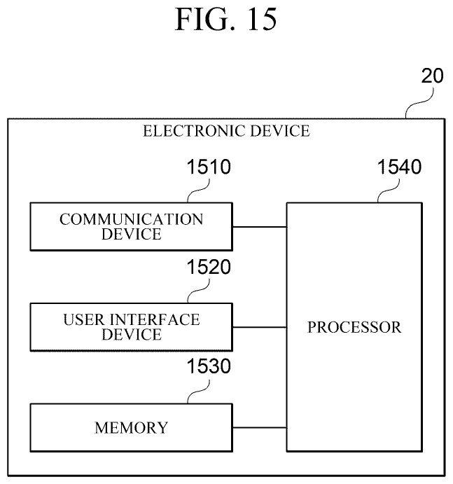

FIG. 15 is a block diagram illustrating the configuration of an electronic device 20 according to one example.

Referring to FIG. 15, the electronic device 20 may include a communication device 1510, a user interface device 1520, a memory 1530 and a processor 1540. However, all the illustrated components are not essential components. The electronic device 20 may be implemented by more components than the illustrated components, and the electronic device 20 may be implemented even by components less than them. Hereinafter, the components will be examined. The electronic device 20 illustrated in FIG. 15 may correspond to the electronic device 20 described in FIG. 1 to FIG. 11c in the same manner.

The communication device 1510 may perform communication with an external device. For example, the communication device 1510 may perform communication with the external device by being connected with a network by wire or wirelessly. Herein, the external device may be the server 10.

The communication device 1510 may include a communication module that supports one of various wired and wireless communication methods. The communication module may be a short-distance communication module, or a wired communication module.

The user interface device 1520 may refer to a device that receives data to control the electronic device 20 from a user. The processor 1540 may control the user interface device 1520 to generate and output a user interface screen for receiving an input of a certain instruction or data from the user.

The user interface device 1520 may include an input unit for receiving an input for controlling operations of the electronic device 20 and the like and an output unit for displaying information such as a state of the electronic device 20 and the like. For example, the user interface device 1520 may include a control panel that receives a user input, a display panel that displays a screen and the like.

Specifically, the input unit may include devices that can receive user inputs in various forms such as for example, a keyboard, a physical button, a touch screen, a camera or a mike and the like. In addition, the output unit may include for example, a display panel or a speaker or the like. However, it is not limited thereto, but the user interface device 1520 may include a device that supports various inputs and outputs.

The memory 1530 may include at least one type of storage medium among a flash memory type, a hard disk type, a multimedia card micro type, a memory in a card type (SD, XD memories, etc.), RAM (Random Access Memory), SRAM (Static Random Access Memory), ROM (Read-Only Memory), EEPROM (Electrically Erasable Programmable Read-Only Memory), PROM (Programmable Read-Only Memory) magnetic memory, a magnetic disk, and an optical disk.

The memory 1530 may store at least one program for executing a method of transmitting scenes and emotion information into the server 10, when the user inputs the emotional state while watching a content, and receiving an additional content and an additional service including emotion information from the server 10, and providing the additional service into the electronic device 20 in the electronic device 20. The at least one program stored in the memory 1530 may be classified into a plurality of modules depending one function of at least one program.

The processor 1540 may control overall operations of the electronic device 20 and include at least one processor such as CPU and the like. The processor 1540 may include at least one specialized processor corresponding to each function, or be a processor in a form integrated into one.

The processor 1540 may execute a program stored in the memory 1530, or read data or a file stored in the memory 1530, or store a new file in the memory 1530. In addition, the processor 1540 may execute instructions stored in the memory 1530.

The processor 1540 may play a content through the user interface device 1520. The user interface device 1520 may receive the emotion information of the user about at least one scene constituting the content, as the content is played.

In addition, the processor 1540 may execute instructions to provide a user interface for settings via the user interface device 1520. Through this settings interface, a user may be allowed to opt-in or opt-out of the emotion tracking feature. Furthermore, the user may be able to control the visibility of their emotional reactions, for example, by setting them to be private, visible only to friends, or public.

The user interface device 1520 may receive the emotion information of the user about the entire scene constituting the content or a part in the scene, based on preset emotion emoticons.

The communication device 1510 may transmit playback time information of at least one scene and emotion information of the user into the server 10.

The communication device 1510 may receive an additional content including the emotion information of the user from the server 10.

The processor 1540 may provide an additional service based on the content, based on at least one of factor information representing a factor by which the emotion information of the user about at least one scene is obtained and an additional content.

For example, the user interface device 1520 may receive an input for selecting a thumbnail of the additional content, and the processor 1540 may play the additional content through the user interface device 1520. In addition, the user interface device 1520 may display the playback time of at least one scene on a search bar while the additional content is played.

For example, the processor 1540 may provide a preview of a content having no playback history, based on factor information indicating a factor by which emotion information of a user about at least one scene of a content.

For example, the processor 1540 may provide a service that can perform communication with a member of a group classified into the same group as the user based on factor information representing a factor by which the emotion information of the user about at least one scene is analyzed.

For example, the processor 1540 may provide a curation service for a plurality of contents, based on the content watched by the member of the group.

For example, the processor 1540 may provide a thumbnail list of an interest scene based on the content watched by the member of the group. For example, the thumbnail list may comprise thumbnails representing high ranking scenes selected according to preset criteria.

The electronic device 20 and server 10 described in the present disclosure may be implemented by hardware components, software components, and/or a combination of hardware components and software components. In addition, the present disclosure may be provided in a form of a computer program stored in a computer readable storage medium so as to perform the operating method of the electronic device 20 and server 10. Moreover, the present disclosure may be written as a program that can be executed in a computer, and may be implemented in a general-purpose digital computer that operates such as program using a computer readable storge medium.

Such a computer readable storage medium may be read-only memory (ROM), random-access memory (RAM), flash memory, CD-ROMs, CD-Rs, CD+Rs, CD-RWs, CD+RW, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, or solid-state disks (SSD), and may be any device which can store instructions or software, related data, data files, and data structures, and provide instructions or software, related data, data files and data structures into a processor or computer so that the processor or computer can execute the instructions.

Examples are described in detail above, but the scope of the present invention is not limited thereto, and various modified and improved forms of those skilled in the art using the basic concept of the present invention defined in the following claims also fall within the scope of the present invention.

The applicability of the present invention is not limited to scripted content like movies or dramas but can be applied to a wide variety of content types. For instance, in a live sports broadcast, users can express emotions like ‘excitement’ during a goal, allowing for the automatic generation of highlight reels. In a music concert, users can record ‘thrilling’ moments during a performance, creating a personalized collection of best stages. For educational content, moments of ‘understanding’ or ‘confusion’ can be marked, providing valuable feedback to instructors and creating customized review sessions.

1. An operating method of a server, comprising
obtaining emotion information of a user about at least one scene constituting a content played on an electronic device;
generating an additional content including the emotion information of the user; and
providing an additional service based on the content into the electronic device, based on at least one of factor information representing a factor by which the emotion information of the user about the at least one scene is obtained and the additional content.

2. The operating method of a server according to claim 1,
wherein the obtaining emotion information of a user about at least one scene,
comprises receiving the emotion information of the user about the entire scene constituting the content or a part of the scene, based on an emotion emoticon preset from the electronic device.

3. The operating method of a server according to claim 1,
further comprising obtaining factor information representing a factor by which emotion information of the user about the at least one scene is obtained,
wherein the obtaining factor information
comprises obtaining configuration information of the at least one scene, including information of objects displayed in the at least one scene and story information of the at least one scene; and
obtaining factor information representing a factor by which the emotion information of the user is obtained, based on results of analyzing a corresponding relation between the configuration information of the at least one scene and the emotion information.

4. The operating method of a server according to claim 1,
further comprising obtaining reference scenes constituting a plurality of contents and emotion information of a plurality of users about the reference scenes; and
generating a first learning model determining factor information representing a factor by which the emotion information of the plurality of users is obtained, based on results of learning configuration information of the reference scenes and the emotion information of the plurality of users.

5. The operating method of a server according to claim 4,
further comprising obtaining the at least one scene and the emotion information of the user about the at least one scene as input values of a first learning model; and
obtaining factor information representing a factor by which the emotion information of the user about the at least one scene is obtained from the first learning model as output values.

6. The operating method of a server according to claim 1,
further comprising collecting reference scenes constituting a plurality of contents and emotion information of a plurality of users about the reference scenes; and
generating a second learning model predicting an interest scene of a certain user in a certain content and emotion information about the interest scene, based on results of learning configuration information of the reference scenes and emotion information of the plurality of users.

7. The operating method of a server according to claim 6,
wherein the providing an additional service based on the content into the electronic device comprises
obtaining factor information representing a factor by which the emotion information of the user about the at least one scene constituting the content is obtained and information of a content different from the content are obtained as input values of the second learning model; and
obtaining at least one interest scene of the user in the different content and emotion information about the at least one interest scene as output values by predicting them from the second learning model; and
providing an interest content based on the at least one interest scene.

8. The operating method of a server according to claim 1,
wherein the additional service based on the content
comprises a curation service for the additional content and at least one content related to the content.

9. The operating method of a server according to claim 1,
wherein the additional content is an image in which the emotion information of the user is displayed in the at least one scene, and
the providing an additional service based on the content
comprises at least one of providing the additional content, when an input for selecting a thumbnail of the additional content is obtained; and
displaying and providing a playback time of the at least one scene on a search bar while the content or the additional content is being played.

10. The operating method of a server according to claim 1,
wherein the providing an additional service based on the content,
comprises providing a preview of a content without playback history, based on factor information representing a factor by which the emotion information of the user about the at least one scene of the content is obtained.

11. The operating method of a server according to claim 1,
further comprising collecting emotion information about scenes constituting a plurality of contents, for each of a plurality of users;
classifying the plurality of users into a plurality of groups, based on the emotion information of the plurality of users; and
providing a curation service for a plurality of contents, for each of the plurality of groups.

12. The operating method of a server according to claim 11,
further comprising providing a space capable of conducting a community, for each of the plurality of groups.

13. The operating method of a server according to claim 11,
wherein the providing curation service
comprises providing a thumbnail list of interest scenes predicted to be of interest to users in a group, for each of the plurality of groups, and
the thumbnail list comprises thumbnails representing high ranking scenes selected according to preset criteria.

14. A server, comprising a communication device which performs communication with an external device;
a processor; and
a memory storing instructions executable by the processor,
wherein the processor executes the instructions, thereby obtaining emotion information of a user about at least one scene constituting a content played on an electronic device, and
generating an additional content including the emotion information of the user, and
providing an additional service based on the content into the electronic device, based on at least one of factor information representing a factor by which the emotion information of the user is obtained about the at least one scene and the additional content.

15. A non-transitory computer-readable storage medium storing instructions that, when executed by a processor of a server, cause the server to perform a method comprising:
obtaining emotion information of a user about at least one scene constituting a content played on an electronic device;
generating an additional content including the emotion information of the user; and
providing an additional service based on the content into the electronic device, based on at least one of factor information representing a factor by which the emotion information of the user for the at least one scene is obtained and the additional content.
